(19) United States
(12) Patent Application Publication
(10) Pub. No.: US 2012/0279081 A1
(43) Pub. Date: Nov. 8, 2012

(54) DEVICE AND METHOD FOR PROCESSING TOBACCO

(75) Inventors: Noel John Totten, Co Antrim North Ireland (GB); Marc Billette, Strassen (LU); Elmar Schloeder, Koewerich (DE); Takuji Harai, Ichikawa (JP); Oleg Fediushin, Trier (DE); Johannes Maerz, Schweich (DE); Andreas Otto, Newel-Butzweiler (DE)

(73) Assignee: JI INTERNATIONAL, S.A., Geneva 26 (CH)

(21) Appl. No.: 13/392,415

(22) PCT Filed: Aug. 25, 2010
(86) PCT No.: PCT/EP2010/062374

§ 371 Date: Jul. 20, 2012

(30) Foreign Application Priority Data
Aug. 26, 2009 (DE) 10 2009 028 913.5

(51) Int. Cl. F26B 21/12; F26B 3/02

(52) U.S. Cl. 34/492; 34/565; 34/487

(57) ABSTRACT

The present invention provides a device and a method, wherein the process conditions can be kept constant in a device for processing tobacco. The device comprises a combining device for combining the tobacco to be processed and a process gas and which is connected to a discharge device for discharging a first quantity of the process gas and a supply device for supplying a second quantity of the process gas; the device having at least one control device for controlling the first quantity of the discharged process gas and/or the second quantity of the supplied process gas.

### CROSS REFERENCE TO RELATED APPLICATION

This application claims the benefit of German patent application No DE 10 2009 028913.5, filed Aug. 26, 2009, the entire disclosure of which is herein incorporated by reference.

### FIELD OF THE INVENTION

The present invention relates to a device and a method for processing tobacco.

Although applicable to any natural products, the present invention and the problem to which it relates are explained in greater detail in relation to processing tobacco.

### BACKGROUND OF THE INVENTION

An important process in processing tobacco is the tobacco being dried to a desired moisture content. It is necessary to dry the tobacco because the drying of the tobacco influences the burning properties and taste properties of the tobacco significantly.

During industrial processing of tobacco, the drying of the tobacco is carried out by means of various drying devices and drying methods. For example, there are known rotationally operating cylinder dryers, in which the tobacco is dried by a process gas in a horizontally orientated drying roller. However, the drying of tobacco in a cylinder dryer is only suitable for the industrial drying of tobacco in some instances because the drying process in a cylinder dryer lasts a relatively long time and is very energy-intensive.

There are further known flow dryers, in which the tobacco is dried in a drying chamber by means of a process gas flow which has superheated water vapour. Drying the tobacco to a desired moisture content takes only a few seconds in such devices. Therefore, flow dryers are very well-suited to industrially processing tobacco. However, a disadvantage of drying tobacco by means of a flow dryer is the generally lesser quality of the dried tobacco.

EP 1188384 A2 discloses, for example, a method and a device for processing tobacco, the tobacco being dried with a process gas which preferably has superheated water vapour. In this instance, the residual gas content in the superheated water vapour is controlled.

In this device for drying tobacco, however, the total quantity of process gas which is in the device fluctuates because the tobacco generally has different moisture contents and therefore different quantities of moisture are discharged into the process gas, and the total quantity of process gas in the device thereby changes. Besides the moisture, other substances are further discharged from the tobacco into the process gas during the drying of the tobacco and make the process gas usable for being recycled for drying the tobacco only to a given extent. For those reasons, there occur undesirable fluctuations in the process conditions because the quantity of the process gas discharged from that device and the quantity of process gas supplied to the device cannot be controlled.

### BRIEF DESCRIPTION OF THE INVENTION

There is accordingly provided a tobacco processing device which has a combining device for combining the tobacco to be processed and a process gas and which is connected to a discharge device for discharging a first quantity of process gas and a supply device for supplying a second quantity of process gas; characterised in that the device has at least one control device for controlling the first quantity of discharged process gas and/or the second quantity of supplied process gas in such a manner that the total quantity of process gas discharged from the device is equal to the total quantity of process gas supplied to the device.

An advantage of this device is that it is possible to control the quantities of supplied process gas and discharged process gas from the combining device for combining the tobacco and the process gas. Those quantities can be adjusted in accordance with the desired drying degree of the tobacco or the type of tobacco. Controlling the first quantity of process gas discharged from the combining device can ensure that the process gas is again optimally suitable for recycling in order to be supplied to the combining device without the process gas having its drying properties impaired and without the qualitative properties of the tobacco fluctuating. It is further possible to convey foreign substances which accumulate in the process gas when the tobacco is being dried out of the device in a quantity determined beforehand by discharging a specific quantity of process gas. This further significantly enhances the qualitative properties of the tobacco. A portion of the gas discharged from the tobacco to the process gas can be recycled and remains in the device. A precise quantity of process gas can be supplied to the device by the supply device. To that end, the supply device preferably has a process gas container for providing the process gas and control devices and actuation members for supplying a precise quantity of process gas. The discharge device preferably comprises a line which is connected to the combining device and a valve, and opens the valve in accordance with the process gas quantity to be discharged. The valve may be in the form of a flap valve and can control the quantity of process gas to be discharged in accordance with the position of the flap. The quantity of process gas supplied can also be controlled in accordance with the tobacco type, moisture content of the tobacco or quantity of the tobacco to be dried. Controlling the total quantity of process gas discharged from the device and the total quantity of process gas supplied to the device can also be referred to as controlling the mass balance of the process gas. The purpose of controlling the mass balance is always to maintain the quantity of process gas in the device at a constant level and thereby to overcome the fluctuations in the process parameters. The mass balance is calculated, for example, in the control device and comprises all the quantities of process gas which are supplied to or discharged from the device. By the mass balance being controlled, it is readily possible in the device for the process gas quantity in the device and the process gas quantity discharged from the device not to fluctuate regardless of all other operating parameters.

According to the invention, there is further provided a method for processing tobacco having the following method steps: combining the tobacco to be processed and a process gas in a combining device; discharging a first quantity of process gas from the combining device by means of a discharge device; supplying a second quantity of process gas to the combining device by means of a supply device; and controlling the first quantity of discharged process gas and the second quantity of supplied process gas, respectively, by means of at least one control device in such a manner that the total quantity of process gas discharged from the device is equal to the total quantity of process gas supplied to the device.

That method is advantageous in the further industrial processing of tobacco because the method advantageously has a short processing time on the one hand and, at the same time, the qualitative properties of the tobacco are kept at a constantly high level. By a previously established quantity of process gas being discharged from the device, it is possible to ensure that the proportion of foreign substances in the process gas is minimised. Furthermore, such a method can be applied to various types of tobacco. It is also further possible to process other products which are processed with a process gas with a method or a device according to the present invention.

Advantageous constructions and developments will be appreciated from the other dependent claims and the description with reference to the figures of the drawings.

According to a preferred embodiment of the invention, the process gas has superheated water vapour and/or ambient air. Superheated water vapour is outstandingly suitable for taking up the moisture of the tobacco and consequently for drying the tobacco. Superheated water vapour is further easy to produce and cost-effective to obtain. A constant oxygen content in the process gas is achieved by means of a specific ratio of superheated water vapour and ambient air. The constant oxygen content is advantageous for the qualitative properties of the tobacco and for the reliability of the device.

According to another preferred embodiment, the device has a tobacco supply device for supplying the tobacco to the combining device, a separating device for separating the tobacco from the process gas and a tobacco discharge device for discharging the tobacco from the separating device. The tobacco supply device may, for example, be in the form of an air lock, via which the tobacco to be dried is conveyed into the combining device. A conveyor belt which provides a specific quantity of tobacco to be dried to the tobacco supply device may, for example, be arranged upstream of the tobacco supply device. For example, the separating device may be in the form of a cyclone, in which the tobacco is separated from the process gas by the tobacco being centrifuged. A conveyor belt for conveying the dried tobacco may also be arranged downstream of the tobacco discharge device.

According to another preferred embodiment, the process gas flows through a circuit connected to the combining device. By using a circuit, the process gas can readily be recycled. The circuit comprises, for example, pipe portions connected to each other. The pipe portions can be produced, for example, from aluminium or another metal.

In another preferred embodiment, the discharge device for discharging the first quantity of process gas from the combining device and the supply device for supplying the second quantity of process gas are connected to the circuit. It is thereby possible not to integrate the discharge device and/or the supply device directly into the combining device. The discharge device and the supply device are connected to the circuit for example by means of connection members, for example, T connection members. It is thereby advantageously possible to supply and discharge the process gas respectively to and from the combining device directly by way of the circuit.

According to another preferred embodiment, there are arranged in the circuit a heating element for heating the process gas and a flow generating device for generating a flow of the process gas. The heating element may be operated, for example, by a gaseous or liquid fuel or by electricity. When the process gas and tobacco are combined, the process gas takes up the moisture of the tobacco, with the process gas becoming cooler. Owing to the heating element arranged in the circuit, it is possible to heat the process gas flowing in the circuit to a desired temperature. The flow generating device may be, for example, a fan or a compressor. It is ensured by the flow generating device that the process gas flows through the circuit at a speed established beforehand and the tobacco to be dried is always subjected to a flow comprising a constant quantity of process gas.

According to another preferred embodiment, the discharge device is arranged downstream of the flow generating device in the direction of flow of the process gas and the supply device is arranged downstream of the discharge device in the direction of flow of the process gas in the circuit. The flow generating device generates in the circuit a pressure which conveys the process gas into the region of the circuit in which a lower pressure is present. Since the discharge device may be formed, for example, by a valve, it is possible, owing to the arrangement of the discharge device downstream of the flow generating device, to use the pressure built up by the flow machine to discharge the process gas from the circuit without a separate drive. The supply device is arranged with adequate spacing from the discharge device in this arrangement of the discharge device in order not to discharge freshly supplied process gas from the device by means of the discharge device.

In another preferred embodiment, the device has an air inlet device for supplying ambient air to the device. By ambient air being supplied to the device, it is possible to operate the device in an energy-saving manner because the quantity of process gas which has to be provided by the supply device becomes smaller. In this instance, the mixing ratio of the process gas and ambient air is not changed. The air inlet device may be in the form of a valve which is connected to the device by means of a line. The valve may be, for example, in the form of a ball valve or flap valve.

According to another preferred embodiment, the air inlet device for supplying ambient air to the circuit is arranged upstream of the flow generating device in the direction of flow of the process gas. The flow generating device reduces the pressure at the side thereof remote from the direction of flow. It is thereby possible to use the reduced pressure in that region to supply ambient air to the device without an additional drive.

According to another preferred embodiment, the device comprises at least one oxygen sensor for measuring the oxygen content of the process gas. That oxygen sensor can be arranged at different locations of the device. For example, an oxygen sensor may be arranged in the circuit directly downstream of the heating element in the direction of flow of the process gas. The oxygen sensor can be connected to the air supply device and/or the control device. The air supply device and/or the control device can then control the oxygen content of the process gas by process gas being supplied, process gas being discharged and/or ambient air being supplied. Since the ambient air has a higher oxygen content than the process gas in the device does, the oxygen content of the process gas is increased by ambient air being supplied.

According to another preferred embodiment, the device has at least one pressure sensor for measuring the pressure of the process gas. The pressure in the device is preferably intended to be only a few Pascal in order to prevent an excessively large loss of process gas through the tobacco supply device and tobacco discharge device. The pressure sensor can be connected to the control device, the supply device and/or the discharge device in order to allow pressure regulation in the device.

According to another preferred embodiment, at least one flow sensor for establishing the flow quantity of the process gas is arranged in the device and particularly in the discharge device. Those flow sensors may be, for example, in the form of Venturi tubes or vortex sensors. Other embodiments or measurement principles of flow sensors are also possible. The flow quantity of the process gas can be converted into a mass flow on the basis of the pressure of the process gas, its density and its temperature. That flow sensor is connected, for example, to the control device, which then controls, on the basis of the actual value of the flow quantity through the device being compared with the desired value of the flow quantity through the device, the quantity of process gas which is supplied to the device by the supply device and controls the quantity which is discharged from the device by means of the discharge device.

In another preferred embodiment, the device has at least one moisture sensor for establishing the moisture content of the tobacco supplied to and/or discharged from the device. The moisture sensors can be arranged, for example, on the tobacco supply device and on the tobacco discharge device and can establish the difference in the moisture content of the supplied and discharged tobacco. Those moisture measurement values can then be supplied, for example, to the control device which then controls the quantity of process gas which is intended to be supplied to and/or discharged from the combining device or the circuit accordingly on the basis of those measurement values. Those measurement values can further also be processed, for example, by the heating element in order to increase the heating output if the tobacco has an excessively high moisture content after being discharged from the device. For that purpose, the heating element has a separate heating element control device. It is also possible to reduce the heating output of the heating element in the event that the moisture content of the tobacco falls below the desired value. It is further possible to influence the moisture content of the dried tobacco by controlling the quantity of tobacco supplied to the device by means of the tobacco supply device. It is also possible to combine the control of the heating output, the quantity of tobacco supplied to the device and the quantity of process gas supplied to the device and the combination may be adapted in accordance with the desired moisture content of the tobacco.

According to another preferred embodiment, the device has at least one temperature sensor for establishing the temperature of the process gas. That temperature sensor may be, for example, a PT100 temperature sensor. That temperature sensor may be arranged, for example, in the combining device or at other locations in the device. The temperature sensor is connected, for example, to the heating element in the circuit or the control device. By a temperature sensor being arranged in the device, it is possible to maintain the temperature of the process gas in the device at a desired value.

According to another preferred embodiment, the control device is connected to the pressure sensor, the flow sensor, the oxygen sensor, the moisture sensor, the temperature sensor, the heating element, the tobacco supply device, the air inlet device, the flow generating device, the supply device for supplying process gas and/or the discharge device for discharging the process gas and controls and/or adjusts the pressure of the process gas, the mass flow of process gas through the circuit, the oxygen content of the process gas, the speed of the process gas flow through the combining device, the temperature of the process gas, the quantity of tobacco supplied to the device by means of the tobacco supply device, the mass flow of process gas through the discharge device and/or the moisture of the tobacco supplied to and discharged from the device. Consequently, it is possible to keep all the relevant process parameters in the device constant.

According to a preferred embodiment, the process gas quantity discharged from the combining device by the discharge device is between 0% and 50% of the process gas in the device and is continuously adjustable. That quantity ensures that the device can dry various types of tobacco and the quantity of foreign substances in the process gas is minimised.

According to another preferred embodiment, the method further has the following method steps: generating a flow of the process gas by means of a flow generating device in a circuit which is connected to the combining device; heating the process gas by means of a heating element; supplying the tobacco to the device by means of a tobacco supply device; drying the tobacco by means of the process gas; separating the tobacco from the process gas by means of a separating device; discharging the tobacco from the separating device; and supplying ambient air to the circuit by means of an air inlet device.

In another preferred embodiment, the method further has the following method steps: measuring the mass flow of the process gas through the circuit by means of a flow sensor; increasing the mass flow of process gas by means of the flow generating device in the event that the mass flow of the process gas through the circuit is too small; or reducing the mass flow of process gas by means of the flow generating device in the event that the mass flow of the process gas through the circuit is too great. The increase in the mass flow of process gas is brought about, for example, by increasing the speed of the fan if the flow generating device is in the form of a fan. That method ensures that the quantity of process gas which flows through the circuit is always constant.

According to another preferred embodiment, the method further has the following method steps: measuring the mass flow through the discharge device by means of a flow sensor; increasing the second quantity of process gas supplied to the device by means of the supply device in the event that the quantity of process gas discharged from the device is too small; or reducing the second quantity of process gas supplied to the device by means of the supply device in the event that the quantity of process gas discharged from the device is too great. For example, the discharge device has a valve and an actuator. The valve may be, for example, in the form of a flap valve. The actuator may be, for example, in the form of an electromotive drive. That method ensures that the quantity of process gas discharged from the device remains at a constant value.

In another preferred embodiment, the method further has the following method steps: measuring the oxygen content of the process gas in the circuit by means of at least one oxygen sensor; supplying ambient air by means of the air inlet device in the event that the oxygen content of the process gas is too low; or supplying process gas to the circuit by means of the supply device and/or reducing the quantity of ambient air supplied by means of the air inlet device in the event that the oxygen content in the process gas is too high. That method ensures that the oxygen content in the process gas is always kept at a constant desired value.

According to another preferred embodiment, the method further has the following method steps: measuring the pressure of the process gas in the circuit by means of at least one pressure sensor; increasing the quantity of process gas discharged from the device by means of the discharge device in the event that the pressure in the device is too high; or reducing the quantity of process gas discharged from the device by means of the discharge device in the event that the pressure in the device is too low. Those method steps ensure that the pressure in the device is always in a constant range.

In another preferred embodiment, the method further has the following method steps: measuring the temperature of the process gas in the circuit; increasing the heating output of the heating element in the event that the temperature of the process gas in the device is too low; or reducing the heating output of the heating element in the event that the temperature of the process gas in the device is too high. Those method steps ensure that the temperature of the process gas is always kept at a desired value.

According to another preferred embodiment, the method further has the following method steps: calculating the second quantity of process gas which is supplied to the combining device by the supply device on the basis of: the loss of the quantity of process gas by the tobacco supply device and the tobacco discharge device; the previously established first quantity of process gas which is discharged from the circuit by means of the discharge device; the quantity of gas which is vaporised by the tobacco and supplied to the circuit; and the quantity of ambient air supplied by the air inlet device. Those method steps ensure that the mass balance of discharged and supplied process gas always remains the same.

### BRIEF DESCRIPTION OF THE DRAWINGS

The invention is explained in greater detail below with reference to embodiments and the appended figures of the drawings, in which:

FIG. 1 is a schematic view of a device for processing tobacco;

FIG. 2 is a graph with a deactivated control device;

FIG. 3 is a graph with an activated control device;

FIG. 4 is a graph with an activated control device.

In the figures of the drawings, the same reference numerals indicate identical or functionally identical components, unless otherwise indicated.

### DETAILED DESCRIPTION OF THE INVENTION

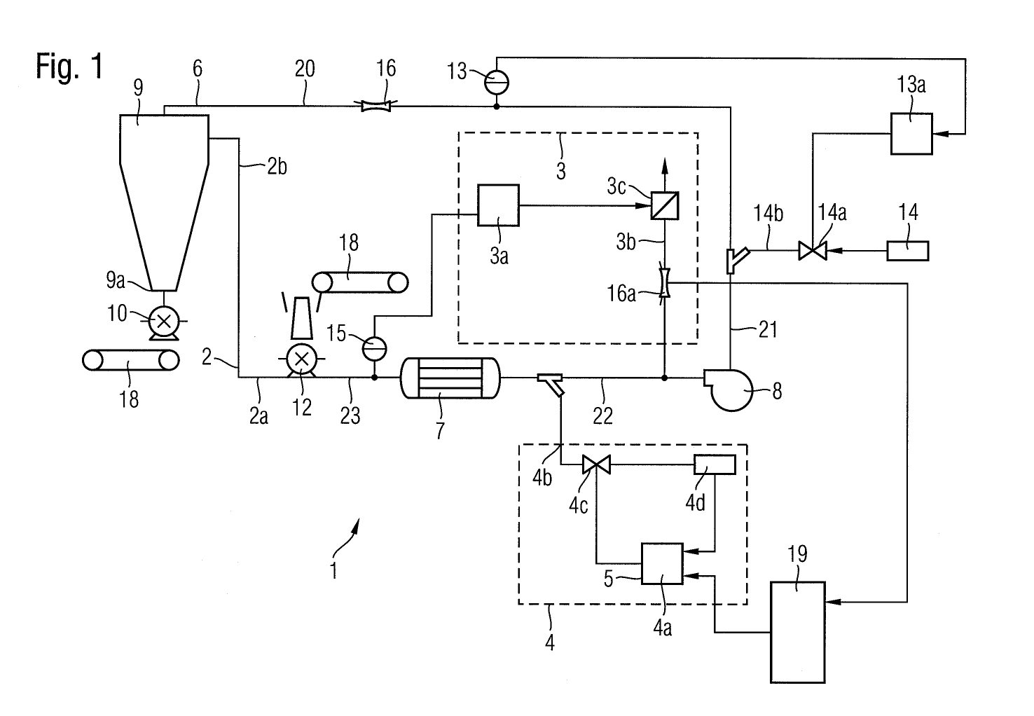

FIG. 1 schematically illustrates a device 1 for processing tobacco. The device 1 has a combining device 2 for combining process gas and tobacco. The combining device 2 is in the form of an ascending pipe in accordance with the present embodiment. At the lower end 2a of the combining device 2, there is arranged a tobacco supply device 12 by which the tobacco is supplied to the combining device 2. At the upper end 2b of the combining device 2, there is arranged a separating device 9 by means of which the tobacco is separated from the process gas. At the bottom 9a of the separating device 9, there is arranged a tobacco discharge device 10 by means of which the tobacco can be discharged from the separating device 9. The combining device 2 is connected to a circuit 6. The circuit 6 is constructed by mutually connected pipe portions and has the pipe portions 20, 21, 22 and 23. A heating element 7 and a flow generating device 8 are further arranged in the circuit 6. The heating element 7 is arranged between the pipe portions 22 and 23. The flow generating device 8 is arranged between the pipe portions 21 and 22.

According to the present embodiment, the process gas flows from the flow generating device 8 in the direction of the heating element 7, in which the process gas is heated to a desired temperature. Subsequently, the process gas is supplied to the pipe portion 23. That pipe portion 23 is connected to the combining device 2. The tobacco supply device 12 is arranged in the transition between the pipe portion 23 and the combining device 2. The tobacco to be dried is supplied to the combining device 2 with the tobacco supply device 12. A conveyor belt 18, with which the tobacco to be dried is supplied to the tobacco supply device 12, is preferably arranged upstream of the tobacco supply device 12. A moisture sensor which measures the moisture content of the tobacco supplied to the device 1 may be arranged at the tobacco supply device 12.

After the tobacco and process gas have been combined at the lower end 2a of the combining device 2, the tobacco is conveyed to the upper end 2b of the combining device 2 by means of the process gas flow and reaches the separating device 9. While the tobacco is being conveyed from the lower end 2a of the combining device 2 to the upper end 2b of the combining device 2, the tobacco is dried to a desired moisture content by the heated process gas. The process gas subsequently reaches the pipe portion 20 from the upper portion of the separating device. A flow sensor 16 is arranged in the pipe portion 20. That flow sensor 16 may be, for example, in the form of a Venturi tube. That flow sensor 16 is integrated in the pipe portion 20 and may be connected, for example, to the discharge device control device 3a or the supply device control device 4a. An oxygen sensor 13 is arranged in the pipe portion 20 downstream of the flow sensor 16. That oxygen sensor 13 is connected to an oxygen control device 13a. The oxygen control device 13a is connected to the air inlet device 14. The air inlet device 14 is arranged at the transition of the pipe portions 20 and 21.

According to the present embodiment, the oxygen control device 13a receives from the oxygen sensor 13 an actual value of the oxygen content of the process gas in the pipe portion 20 and compares that oxygen content of the process gas with a desired value established beforehand. If the oxygen content of the process gas is too low, the oxygen control device 13a opens the valve 14a of the air inlet device 14 which connects the pipe portion 21 to the outer region of the device 1 by means of a connection member 14b. Under specific operating conditions, reduced pressure relative to the pressure of the ambient air is present in that portion of the pipe portion 21 owing to the flow generating device 8 so that ambient air is supplied to the circuit 6 when a valve 14a is opened between the pipe portions 20 and 21. Under specific operating conditions, however, it is also possible for overpressure relative to the ambient air to be present in that portion. In that case, the oxygen content of the process gas is increased in that the pressure of the process gas within the circuit is reduced so that ambient air is supplied to the device by the interfaces of the device, for example, by the tobacco supply device or the tobacco discharge device. After that portion of the pipe portion 21, the process gas reaches the flow generating device 8, in which the process gas is compressed and is again supplied to the pipe portion 22.

The discharge device 3 is arranged downstream of the flow generating device 8. The discharge device 3 is connected to the pipe portion 22 by means of a discharge device pipe portion 3b. The discharge device 3 has a valve 3c which may be, for example, in the form of a flap valve or the like. A flow sensor 16a is further arranged in the discharge device pipe portion 3b. The discharge device 3 is connected to a discharge device control device 3a. That discharge device control device 3a is in turn connected to a pressure sensor 15 which is in the pipe portion 23 in the present embodiment. However, that pressure sensor 15 may alternatively also be arranged at a different location of the device 1.

The discharge device control device 3a receives from the pressure sensor 15 a pressure signal and compares that pressure value with a previously established desired value. If the pressure in the process gas is too great, the discharge device control device 3a can open the valve 3c of the discharge device 3 and thereby reduce the pressure of the process gas in the circuit 6. The quantity of process gas which is discharged by the discharge device 3 to the environment can be measured by means of the flow sensor 16a which is arranged in the discharge device pipe portion 3b.

In addition to the discharge device 3, the supply device 4 for supplying process gas to the circuit 6 is located in the pipe portion 22. The supply device 4 is arranged, for example, upstream of the heating element 7 and with adequate spacing from the discharge device 3. The supply device 4 is connected to the pipe portion 22 by means of a supply device pipe portion 4b. The supply device 4 has a process gas container 4d, in which superheated water vapour is produced. That process gas container 4d is connected to a valve 4c which is connected to the supply device pipe portion 4b. The supply device which is designated 4 further has a supply device control device 4a which can control the valve 4c of the supply device 4 by means of an actuator. In this instance, the supply device 4 is also provided with a flow sensor in order to measure the quantity of process gas supplied to the circuit 6.

The device 1 further has a processing unit 19, with which it is possible to establish the quantity of process gas to be supplied. That processing unit 19 may be, for example, in the form of a microcontroller. The quantity of process gas to be supplied is calculated from the quantity which is discharged by the discharge device 3 from the circuit 6, the quantity of process gas which is discharged from the device 1 through the tobacco supply device 12 and the tobacco discharge device 10, the desired value of the quantity of process gas which flows through the entire device 1 and which is measured by the flow sensor 16 in the pipe portion 20 and the quantity of process gas which is discharged from the tobacco to the process gas. That processing unit 19 further receives measurement values of the pressure sensors 15 in the device 1, the temperature sensors 17 in the device 1, the oxygen sensors 13 in the device 1 and the flow sensors 16 and 16a in the device.

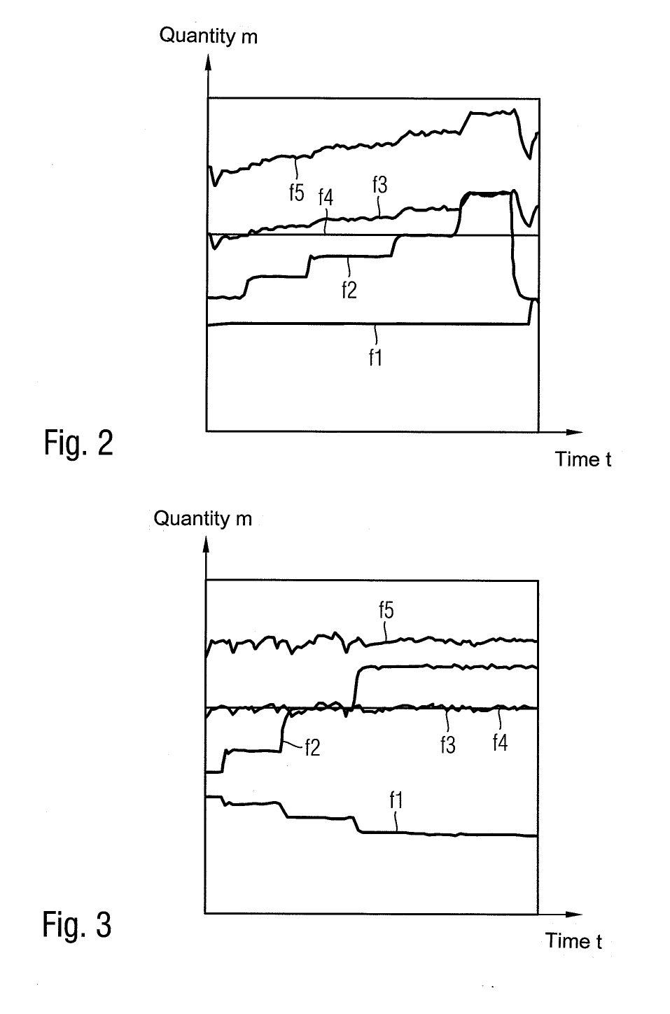

FIG. 2 is a graph of the process parameters of the device for processing tobacco with a deactivated control device. The longitudinal axis of the graph represents the time axis t and the vertical axis represents the quantities m. The line f1 shows the mass flow of process gas supplied. The line f2 shows the quantity of process gas discharged from the tobacco to the process gas. The line f3 shows the actual value of the ratio of the discharged quantity of process gas to the total quantity of process gas which is in the device. The line f4 represents the desired value of the ratio of the discharged process gas quantity to the process gas quantity in the device. The line f5 shows the actual value of the mass flow of process gas which is discharged from the device. It is evident that the quantity of process gas supplied with a control device deactivated is constant. The line f1 does not change during that measurement. This represents operation of the device during which it is assumed that the quantity of process gas which is discharged from the tobacco to the device does not change. The line f2 is of step-like form. That step-like formation of the line f2 was simulated, for the purposes of simulation and for illustration, with a replacement charge which discharges an adjustable quantity of process gas to the device. It is evident that the actual value of the ratio of the process gas quantity discharged to the total quantity of process gas in the device increases constantly (line f3) and the difference between the actual value f3 and the desired value f4 becomes greater as time progresses.

There is a direct connection between the increase in the quantity of process gas discharged from the device (line f5) and the quantity of process gas which has been discharged by the tobacco or replacement charge (line f2). It is further apparent in FIG. 2 that the mass flow of discharged process gas (line f5) increases constantly and does not remain at a constant level. In such a device, it is also impossible to ensure constant process conditions owing to the non-constant value of the quantity of process gas discharged from the device.

FIG. 3 is a graph of process parameters of the device for processing tobacco with a control device activated. The lines are indicated in a similar manner to FIG. 2 and represent the same process parameters. It is evident from line f2 that the quantity of process gas discharged from the tobacco is also increased. This also occurs with a replacement charge. The increase in the process gas quantity in the device is measured by the sensors which are arranged in the device. By means of the mass balance model, the necessary reduced quantity of process gas supplied is then immediately calculated, for example, by means of the control device and supplied to the device by means of the supply device in order to compensate for the increased process gas quantity in the device. This is illustrated in the line f1. This is brought about, for example, by a change in the position of the flap of a flap valve which is arranged in the supply device.

It is apparent in FIG. 3 that the actual value of the ratio of the discharged process gas quantity to the quantity of process gas in the device has a constant value over the entire measurement range. The deviation of the actual value from the desired value is only slight. It is further visible in the line f5 that the mass flow of discharged process gas also moves in a constant range over the entire measurement range and has only slight deviations.

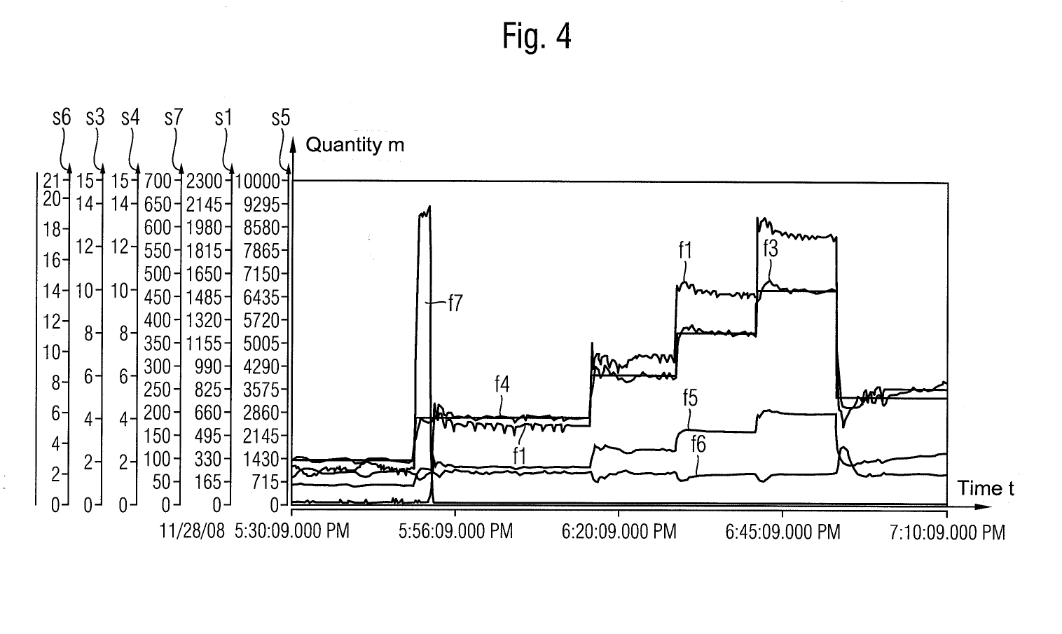

FIG. 4 is a graph of process parameters with an actuated control device, wherein there are further illustrated the units of quantity m and the time axis t with associated values. The scales of quantity are set out on the left-hand side. The scale s6 represents the oxygen content of the process gas and has a range of from 0 to 21 percent oxygen. The scale s3 represents the actual value and the scale s4 represents the desired value of the ratio of the discharged process gas quantity to the process gas quantity in the device in percent and they have values of between 0 and 15 percent. The scale s1 represents the mass flow of process gas supplied in kilograms per hour and has a range of values of from 0 to 2300 kilograms per hour. The scale s5 represents the mass flow of process gas from the device, which flow is measured by the flow sensor in the discharge device. The scale s5 also has the unit kilograms per hour and has a range of values of from 0 to 1000 kilograms per hour. The time axis z is further illustrated in the graph. The times are set out in hours and minutes. This graph represents the process conditions in the device, in which it is assumed that 350 kg of water per hour is discharged from the tobacco to the process gas. The desired value of the ratio of discharged process gas quantity to the process gas quantity in the device is further increased in five steps of two percent from two to ten percent. That desired value is represented by the line f4. It is apparent that the ratio of the discharged process gas quantity to the process gas quantity in the device can be very well controlled at all levels (line f3). The control time is further very rapid and lasts a small number of seconds. It is further apparent that the oxygen content (line f6) of the process gas can also be kept constant in all adjustments of the device.

Although the present invention has been described completely with reference to a preferred embodiment, it is not limited thereto but may be modified in various manners.

For example, it is possible to combine all the control devices, such as the oxygen control device, the discharge device control device or the supply device control device, in a central control device. That central control device monitors all the process parameters by means of the sensors in the device and is connected to all the actuators in the device. For different types of tobacco, there are different control programs which optimally adapt the optimum temperature of the process gas as well as the pressure and the flow speed of the process gas depending on the type of tobacco. The device can further be connected to other devices for processing tobacco which, for example, cut, preheat. moisten, expand, classify, flavour or cool the tobacco.

Since the system of the device for processing tobacco has a high inertia and changes in the process parameters thereby become apparent in the whole device only after a given period of time, the control device can further be provided with a so-called feed forward control system. That feed forward control system is distinguished in that the process parameters are controlled by the control device without measurement data, for example the flow quantity through the device, being fed back. For example, a constant value for the total quantity of process gas is adjusted in the device in the event of a change in the ratio of the process gas quantity discharged to the process gas quantity in the device only after a given time. In the case of conventional control, for example by a PID controller, the control device reacts only to a deviation of the actual value from the desired value. This is undesirable in the device for processing tobacco because the process parameters, such as the temperature, the oxygen content of the process gas or the flow quantity of process gas, are always intended to be maintained at a constant value in order to ensure constant process conditions. In the case of a feed forward control system, for example, the quantity of process gas which is further lost in the event of an increase in the mass flow of discharged process gas is compensated for in that the quantity of process gas which is additionally discharged from the device is already known beforehand from experimental tests and can subsequently be supplied to the device by the supply device. Therefore, only very slight deviations of the process parameters from the necessary desired values occur.

### EMBODIMENTS

1. Device (1) for processing tobacco, comprising:

a combining device (2) for combining the tobacco to be processed and a process gas and which is connected to a discharge device (3) for discharging a first quantity of process gas and a supply device (4) for supplying a second quantity of process gas;

characterised in that

the device (1) has at least one control device (5) for controlling the first quantity of discharged process gas and the second quantity of supplied process gas in such a manner that the total quantity of process gas discharged from the device (1) is equal to the total quantity of process gas supplied to the device (1).

2. Device (1) according to embodiment 1,

characterised in that

the process gas has superheated water vapour and/or ambient air.

3. Device (1) according to embodiment 1 or embodiment 2,

characterised in that

the device (1) has a tobacco supply device (12) for supplying the tobacco to the combining device (2), a separating device (9) for separating the tobacco from the process gas and a tobacco discharge device (10) for discharging the tobacco from the separating device (9).

4. Device (1) according to at least one of the preceding embodiments,

characterised in that

the process gas flows through a circuit (6) connected to the combining device (2).

5. Device (1) according to embodiment 4,

characterised in that

the discharge device (3) for discharging the first quantity of process gas from the combining device (2) and the supply device (4) for supplying the second quantity of process gas are connected to the circuit (6).

6. Device (1) according to embodiment 4 or embodiment 5,

characterised in that

there are arranged in the circuit (6) a heating element (7) for heating the process gas and a flow generating device (8) for generating a flow of the process gas in the circuit (6).

7. Device (1) according to embodiment 6,

characterised in that

the discharge device (3) is arranged downstream of the flow generating device (8) in the direction of flow of the process gas and the supply device (4) is arranged downstream of the discharge device (3) in the direction of flow of the process gas in the circuit.

8. Device according to at least one of the preceding embodiments,

characterised in that

the device (1) has an air inlet device (14) for supplying ambient air to the device (1).

9. Device (1) according to embodiment 8 when dependent on embodiment 6 or embodiment 7,

characterised in that

the air inlet device (14) for supplying ambient air to the circuit (6) is arranged upstream of the flow generating device (8) in the direction of flow of the process gas.

10. Device (1) according to at least one of the preceding embodiments,

characterised in that

the device (1) has at least one oxygen sensor (13) for measuring the oxygen content of the process gas.

11. Device (1) according to at least one of the preceding embodiments,

characterised in that

the device (1) has at least one pressure sensor (15) for measuring the pressure of the process gas.

12. Device (1) according to at least one of embodiments 3 to 11,

characterised in that

at least one flow sensor (16) for establishing the flow quantity of the process gas is arranged in the circuit (6) and particularly in the discharge device (3).

13. Device according to at least one of the preceding embodiments,

characterised in that

the device (1) has at least one moisture sensor (11) for establishing the moisture content of the tobacco supplied to and/or tobacco discharged from the device (1).

14. Device (1) according to at least one of the preceding embodiments,

characterised in that

the device (1) has at least one temperature sensor (17) for establishing the temperature of the process gas.

15. Device (1) according to embodiment 14,

characterised in that

the control device (5) is connected to the pressure sensor (15), the flow sensor (16), the oxygen sensor (13), the moisture sensor (11), the temperature sensor (17), the tobacco supply device (12), the heating element (7), the air inlet device (14), the flow generating device (8), the supply device (4) for supplying process gas and/or the discharge device (3) for discharging the process gas and controls and/or adjusts the pressure of the process gas, the tobacco quantity which is supplied to the device by means of the tobacco supply device (12), the mass flow of process gas through the circuit (6), the oxygen content of the process gas, the speed of the process gas flow through the combining device (2), the temperature of the process gas, the mass flow of process gas through the discharge device (3) and/or the moisture of the tobacco supplied to and discharged from the device (1).

16. Method for processing tobacco, having the following method steps:

combining the tobacco to be processed and a process gas in a combining device (2);

discharging a first quantity of process gas from the combining device (2) by means of a discharge device (3);

supplying a second quantity of process gas to the combining device (2) by means of a supply device (4); and

controlling the first quantity of discharged process gas and the second quantity of supplied process gas by means of at least one control device (5) in such a manner that the total quantity of process gas discharged from the device (1) is equal to the total quantity of process gas supplied to the device (1).

17. Method according to embodiment 17,

characterised in that

the process gas quantity discharged from the combining device (2) by the discharge device (3) is between 0% and 50% of the process gas in the device (1) and is continuously adjustable.

18. Method according to embodiment 16 or embodiment 17,

characterised in that

the method further has the following method steps:

generating a flow of the process gas by means of a flow generating device (8) in a circuit (6) which is connected to the combining device (2);

heating the process gas by means of a heating element (7);

supplying the tobacco to the combining device (2) by means of a tobacco supply device (10);

drying the tobacco by means of the process gas;

separating the tobacco from the process gas by means of a separating device (9);

discharging the tobacco from the separating device (9); and

supplying ambient air to the circuit (6) by means of an air inlet device (14).

19. Method according to embodiment 18,

characterised in that

the method further has the following method steps:

measuring the mass flow of the process gas through the circuit (6) by means of a flow sensor (16);

increasing the mass flow of process gas by means of the flow generating device (8) in the event that the mass flow of the process gas through the circuit (6) is too small; or

reducing the mass flow of process gas by means of the flow generating device (8) in the event that the mass flow of the process gas through the circuit (6) is too great.

20. Method according to at least one of embodiments 16 to 19,

characterised in that

the method further has the following method steps:

measuring the mass flow through the discharge device (3) by means of a flow sensor (16); increasing the second quantity of process gas supplied to the device by means of the supply device (4) in the event that the quantity of process gas discharged from the device (1) is too small; or

reducing the second quantity of process gas supplied to the device (1) by means of the supply device (4) in the event that the quantity of process gas discharged from the device (1) is too great.

21. Method according to at least one of embodiments 16 to 20,

characterised in that

the method further has the following method steps:

measuring the oxygen content of the process gas in the device (1) by means of at least one oxygen sensor (13);

supplying ambient air by means of an air inlet device (14) in the event that the oxygen content of the process gas is too low; or

supplying process gas to the device (1) by means of the supply device (4) and/or reducing the quantity of ambient air supplied by means of the air inlet device in the event that the oxygen content of the process gas is too high.

22. Method according to at least one of embodiments 16 to 21,

characterised in that

the method further has the following method steps:

measuring the pressure of the process gas in the device (1) by means of at least one pressure sensor (15);

increasing the first quantity of process gas discharged from the device by means of the discharge device (3) in the event that the pressure in the device (1) is too high; or

reducing the first quantity of process gas discharged from the device by means of the discharge device (3) in the event that the pressure in the device (1) is too low.

23. Method according to at least one of embodiments 18 to 22,

characterised in that

the method further has the following method steps: measuring the temperature of the process gas in the device (1);

increasing the heating output of the heating element (7) in the event that the temperature of the process gas in the device (1) is too low; or

reducing the heating output of the heating element (7) in the event that the temperature of the process gas in the device (1) is too high.

24. Method according to at least one of embodiments 21 to 23,

characterised in that

the method further has the following method steps:

calculating the second quantity of process gas which is supplied to the combining device (2) by the supply device (4) in accordance with: the loss of the quantity of process gas by the tobacco supply device (12) and the tobacco discharge device (10), the previously established first quantity of process gas which is discharged from the circuit (6) by means of the discharge device (3), the quantity of process gas which is vaporised by the tobacco and supplied to the circuit (6), and the quantity of ambient air supplied by the air inlet device (14).

1. Device for processing tobacco, comprising:
a combining device for combining the tobacco to be processed and a process gas, such as superheated water vapour and/or ambient air, and which is connected to a discharge device for discharging a first quantity of process gas and a supply device for supplying a second quantity of process gas;
wherein
the device has at least one control device for controlling the first quantity of discharged process gas and the second quantity of supplied process gas in such a manner that the total quantity of process gas discharged from the device is equal to the total quantity of process gas supplied to the device.

2. Device according to claim 1,
wherein
the device has a tobacco supply device for supplying the tobacco to the combining device, a separating device for separating the tobacco from the process gas and a tobacco discharge device for discharging the tobacco from the separating device.

3. Device according to claim 1,
wherein
the process gas flows through a circuit connected to the combining device and in that the discharge device for discharging the first quantity of process gas from the combining device and the supply device for supplying the second quantity of process gas are connected to the circuit.

4. Device according to claim 3,
wherein
there are arranged in the circuit a heating element for heating the process gas and a flow generating device for generating a flow of the process gas in the circuit.

5. Device according to claim 4,
wherein
the discharge device is arranged downstream of the flow generating device in the direction of flow of the process gas and the supply device is arranged downstream of the discharge device in the direction of flow of the process gas in the circuit.

6. Device according to claim 1,
wherein
the device has an air inlet device for supplying ambient air to the circuit is arranged upstream of the flow generating device in the direction of flow of the process gas.

7. Device according to claim 6,
wherein
the control device is connected to a pressure sensor for measuring the pressure of the process gas, at least one flow sensor for establishing the flow quantity of the process gas arranged in the circuit and particularly in the discharge device, an oxygen sensor for measuring the oxygen content of the process gas, a moisture sensor for establishing the moisture content of the tobacco supplied to and/or tobacco discharged from the device, a temperature sensor for establishing the temperature of the process gas, the tobacco supply device, the heating element, the air inlet device, the flow generating device, the supply device for supplying process gas and/or the discharge device for discharging the process gas and controls and/or adjusts the pressure of the process gas, the tobacco quantity which is supplied to the device by means of the tobacco supply device, the mass flow of process gas through the circuit, the oxygen content of the process gas, the speed of the process gas flow through the combining device, the temperature of the process gas, the mass flow of process gas through the discharge device and/or the moisture of the tobacco supplied to and discharged from the device.

8. Method for processing tobacco, having the following method steps:
combining the tobacco to be processed and a process gas in a combining device;
discharging a first quantity of process gas from the combining device by means of a discharge device;
supplying a second quantity of process gas to the combining device by means of a supply device; and
controlling the first quantity of discharged process gas and the second quantity of supplied process gas by means of at least one control device in such a manner that the total quantity of process gas discharged from the device is equal to the total quantity of process gas supplied to the device.

9. Method according to claim 8,
wherein
the process gas quantity discharged from the combining device by the discharge device is between 0% and 50% of the process gas in the device and is continuously adjustable.

10. Method according to claim 8,
wherein
the method further has the following method steps:
generating a flow of the process gas by means of a flow generating device in a circuit which is connected to the combining device;
heating the process gas by means of a heating element;
supplying the tobacco to the combining device by means of a tobacco supply device;
drying the tobacco by means of the process gas;
separating the tobacco from the process gas by means of a separating device;
discharging the tobacco from the separating device; and
supplying ambient air to the circuit by means of an air inlet device.

11. Method according to claim 10,
wherein
the method further has the following method steps:
measuring the mass flow of the process gas through the circuit by means of a flow sensor;
increasing the mass flow of process gas by means of the flow generating device in the event that the mass flow of the process gas through the circuit is too small; or
reducing the mass flow of process gas by means of the flow generating device in the event that the mass flow of the process gas through the circuit is too great.

12. Method according to claim 8,
wherein
the method further has the following method steps:
measuring the mass flow through the discharge device by means of a flow sensor;
increasing the second quantity of process gas supplied to the device by means of the supply device in the event that the quantity of process gas discharged from the device is too small; or
reducing the second quantity of process gas supplied to the device by means of the supply device in the event that the quantity of process gas discharged from the device is too great.

13. Method according to claim 8,
wherein
the method further has the following method steps:
measuring the oxygen content of the process gas in the device by means of at least one oxygen sensor;
supplying ambient air by means of an air inlet device in the event that the oxygen content of the process gas is too low; or
supplying process gas to the device by means of the supply device and/or reducing the quantity of ambient air supplied by means of the air inlet device in the event that the oxygen content of the process gas is too high.

14. Method according to claim 10,
wherein
the method further has the following method steps:
measuring the pressure of the process gas in the device by means of at least one pressure sensor;
increasing the first quantity of process gas discharged from the device by means of the discharge device in the event that the pressure in the device is too high; or
reducing the first quantity of process gas discharged from the device by means of the discharge device in the event that the pressure in the device is too low.

15. Method according to claim 12,
wherein
the method further has the following method steps:
calculating the second quantity of process gas which is supplied to the combining device by the supply device in accordance with: the loss of the quantity of process gas by the tobacco supply device and the tobacco discharge device, the previously established first quantity of process gas which is discharged from the circuit by means of the discharge device, the quantity of process gas which is vaporised by the tobacco and supplied to the circuit, and the quantity of ambient air supplied by the air inlet device.
